(19) United States
(12) Patent Application Publication
(10) Pub. No.: US 2013/0292460 A1
(43) Pub. Date: Nov. 7, 2013

(54) Control of Devices via Interaction with an Object

(71) Applicant: James M. Hunter, San Jose, CA (US)

(72) Inventor: James M. Hunter, San Jose, CA (US)

(73) Assignee: General Instrument Corporation, Horsham, PA (US)

(21) Appl. No.: 13/463,121

(22) Filed: May 3, 2012

(51) Int. Cl. G06F 21/00; G06K 5/00; G06F 17/00; G06F 15/16

(52) U.S. Cl. 235/375; 726/3

(57) ABSTRACT

A method includes interacting, by a mobile device, with an object associated with a set of controllable devices that are provided for demonstration to a user of the mobile device. The method determines information associated with the object based on the interaction and sends the information to a server to open an authenticated session with the server. The server opens the authenticated session that allows temporary access to automatically control the set of controllable devices via an application running on the mobile device. The mobile device sends a command to the server to control a controllable device in the set of controllable devices. The server allows control of the controllable device based on the command if the temporary access to the authenticated session is determined to be valid for the mobile device and disallow the control of the controllable device if the authenticated session is determined to be invalid.

### BACKGROUND

Particular embodiments generally relate to automatic device control.

A user may automatically control controllable devices that the users owns in a location, such as the user's home. For example, from the user's mobile device, the user may control the dimming of different lights, the unlocking or locking of doors, or the turning on/turning off of different appliances. Typically, the user purchases these devices and manually sets up his/her mobile device to automatically control these devices in the user's home. Once set up, upon logging in and providing credentials to an application, the user may automatically be given access to the devices and be allowed to control them.

When a user wants to purchase a new device, the user may go to a location that is selling the devices, such as a store or website. The store may have a demonstration set up where the user can view the devices. The user may be able to use the devices themselves. For example, the user may be able to turn a light on and off with controls on the light. However, the user would not be able to control the light using a mobile device. Thus, a user cannot experience the environment used to control controllable devices. If the user purchases the devices and sets the devices up in his/her home, there is a chance the user may not be satisfied with the purchase when the user starts controlling the devices automatically from the user's mobile device for the first time.

### BRIEF DESCRIPTION OF THE DRAWINGS

FIG. 1 depicts a simplified system for automatically controlling controllable devices 102 according to one embodiment.

FIG. 2 depicts a simplified flowchart for allowing a mobile device to set up and control controllable devices according to one embodiment.

FIG. 3 depicts a simplified flowchart for automatically controlling controllable devices at a control point according to one embodiment.

FIG. 4 depicts a more detailed example of the mobile device according to one embodiment.

FIG. 5 depicts a more detailed example of the control point according to one embodiment.

### DETAILED DESCRIPTION

Described herein are techniques for a device control system. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

In one embodiment, a method includes interacting, by a mobile device, with an object associated with a set of controllable devices that are provided for demonstration to a user of the mobile device. The method determines information associated with the object based on the interaction and sends the information to a server to open an authenticated session with the server. The server opens the authenticated session based on the receiving of the information from the mobile device and the authenticated session allows temporary access to automatically control the set of controllable devices via an application running on the mobile device. The mobile device sends a command to the server to control a controllable device in the set of controllable devices. The server is configured to allow control of the controllable device based on the command if the temporary access to the authenticated session is determined to be valid for the mobile device and disallow the control of the controllable device if the authenticated session is determined to be invalid.

In one embodiment, a non-transitory computer-readable storage medium is provided that contains instructions for controlling a computer system to be operable for: interacting, by a mobile device, with an object associated with a set of controllable devices that are provided for demonstration to a user of the mobile device; determining information associated with the object based on the interaction; sending the information to a server to open an authenticated session with the server, wherein the server opens the authenticated session based on the receiving of the information from the mobile device and the authenticated session allows temporary access to automatically control the set of controllable devices via an application running on the mobile device; and sending, by the mobile device, a command to the server to control a controllable device in the set of controllable devices, wherein the server is configured to allow control of the controllable device based on the command if the temporary access to the authenticated session is determined to be valid for the mobile device and disallow the control of the controllable device if the authenticated session is determined to be invalid.

In one embodiment, a method is provided comprising: receiving, at a server, information associated with an object to open an authenticated session with mobile device, wherein the mobile device determined the information by interacting with the object associated with a set of controllable devices that are provided for demonstration to a user of the mobile device; opening the authenticated session with the mobile device based on the receiving of the information associated with the object from the mobile device, wherein the authenticated session allows temporary access to automatically control the set of controllable devices via an application running on the mobile device; receiving, at the server, a command from the mobile device to control a controllable device of the set of controllable devices; validating if the temporary access is still valid for the authenticated session; if the temporary access to the authenticated session is determined to be valid for the mobile device, allowing control of the controllable device based on the command; and if the authenticated session is determined to be invalid, disallowing the control of the controllable device.

In one embodiment, a non-transitory computer-readable storage medium is provided that contains instructions for controlling a computer system to be operable for: receiving, at a server, information associated with an object to open an authenticated session with mobile device, wherein the mobile device determined the information by interacting with the object associated with a set of controllable devices that are provided for demonstration to a user of the mobile device; opening the authenticated session with the mobile device based on the receiving of the information associated with the object from the mobile device, wherein the authenticated session allows temporary access to automatically control the set of controllable devices via an application running on the mobile device; receiving, at the server, a command from the mobile device to control a controllable device of the set of controllable devices; validating if the temporary access is still valid for the authenticated session; if the temporary access to the authenticated session is determined to be valid for the mobile device, allowing control of the controllable device based on the command; and if the authenticated session is determined to be invalid, disallowing the control of the controllable device.

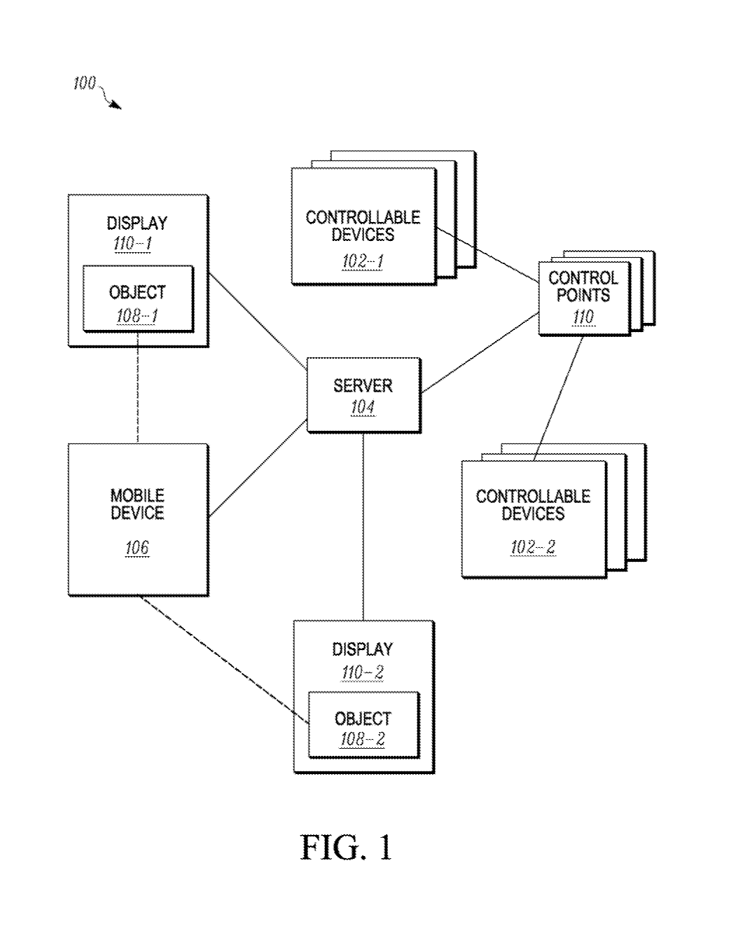

FIG. 1 depicts a simplified system 100 for automatically controlling controllable devices 102 according to one embodiment. System 100 may include controllable devices 102 that are set up in a demonstration, which may be in an environment in which controllable devices 102 can be automatically controlled. The demonstration may be in a location, such as a store, warehouse, or staging area. A user may not be physically in the same location as controllable devices 102. For example, the user may be viewing a web page that shows controllable devices 102, such as a camera feed is shown where the user can control a camera.

In one embodiment, a company is offering controllable devices 102 for sale or may be offering services based on controllable devices 102. The demonstration of controllable devices 102 may be helpful for a user. As will be discussed in more detail below, a user may use a mobile device 106 to automatically control controllable devices 102. Mobile device 106 may be owned by the user and/or may not have any prior affiliation with the store or controllable devices 102 in the demonstration. For example, the user may use mobile device 106 to control controllable devices 102 that are set up for a demonstration on the floor of the store. Also, controllable devices 102 may be set up in a remote location where a user can control controllable devices 102 in the remote location or controllable devices 102 in the field of view of the camera.

Controllable devices 102 include physical devices, such as lights, televisions, applications, and thermostats. Also, controllable devices 102 include virtual devices, such as applications, content, music, and content feeds. Other controllable devices 102 may also be appreciated. Also, when the term controllable device is used, it will be understood that the controllable device may be a virtual or physical device.

Examples of mobile device 106 include a smartphone, a tablet computer, a netbook computer, a laptop computer, or any other suitable device. In one embodiment, mobile device 106 may be owned by the user and not by a company that is demonstrating or owns controllable devices 106. For example, the company may not have purchased mobile device 106, previously owned mobile device 106 and sold mobile device 106, or given mobile device 106 to the user. Thus, the company does not have a prior affiliation with mobile device 106 that is being used by the user. Because mobile device 106 is not affiliated with the company, mobile device 106 may not be automatically authorized or configured to control controllable devices 102. For example, a user may walk into a store and cannot control controllable devices 102 with his/her mobile device 106 because the user's mobile device 106 has no prior affiliation with a network that is used to control controllable devices 102 in the store. Also, a user may log onto a website and cannot control controllable devices 102 shown on a web page for the website. However, it might be useful for the company to allow the user to control controllable devices 102 using the user's own mobile device 106. This would enhance the experience for the user in that the user can see how controllable devices 102 can be controlled using a mobile device 106 that the user may use in the user's home or business. Further, since the user owns mobile device 106, the user would not have to wait in line in order to demo the control of controllable devices 102.

One or more control points 110 may control controllable devices 102. Control point 110 may cause actions to be performed with controllable devices 102. For example, controllable features, such as a temperature or on/off switch, of controllable devices 102 are controlled through mobile device 106. For example, control point 110 may turn controllable devices 102 on or off or adjust a value of the temperature of a thermostat. In one embodiment, control point 104 may communicate through a network (not shown), and may also use other control points or network devices to control controllable devices 102.

Particular embodiments provide an object 108 that is associated with a set of controllable devices 102. The set of controllable devices 102 may include a single controllable device 102 or multiple controllable devices 102. In one embodiment, object 108 may include a graphical representation of object 108. For example, the graphical representation of object 108 is a two-dimensional image generated by applying an encoding process to information for object 108. The graphical representation of the object 108 may include an identifier (e.g., a uniform resource locator (URL)) for the set of controllable devices 102 (e.g., different sets of controllable devices 102 are identified differently). In one example, the graphical representation of object 108 is a quick response (QR) code or any other suitable image, such as a bar code. As another example, information included in the graphical representation of object 108 may be captured via an electronic communication, such as near field communication (NFC).

Object 108 may be displayed on a display 110. For example, object 108 may be displayed on a physical display, such as a piece of paper that is set up by controllable devices 102. Also, object 108 may be displayed on an electronic display, such as a computer screen. Additionally, object 108 may not be displayed, but may be available for transfer to mobile device 106 electronically. In this case, a computing device is provided that allows for this transfer.

When mobile device 106 interacts with object 108, particular embodiments allow mobile device 106 to control the set of controllable devices 102 that is associated with object 108. For example, the interaction allows mobile device 106 to capture object 108, such as by scanning or taking a picture of object 108 using a scanner/camera of mobile device 106. In another embodiment, other communications may be used to capture object 108. For example, mobile device 106 uses near-field communication to transfer object 108 to mobile device 106.

Mobile device 106 can then use object 108 to facilitate control of controllable devices 102. For example, mobile device 106 may send information determined from object 108 (e.g., a decoded URL from the QR code) to a server 104. Server 104 then allows mobile device 106 to control the set of controllable devices 102 that are associated with that object 108. For example, if mobile device 106 captured object 108-1, then server 104 would allow mobile device 106 to control a set of controllable devices 102-1 via control point 110 upon receiving object 108-1. In one embodiment, server 104 determines an identifier for object 108 and looks up which set of controllable devices 102 are associated with the identifier. Also, if mobile device 106 captured object 108-2, then server 104 would allow mobile device 106 to control controllable device 102-2 via control point 110 upon receiving object 108-2.

Accordingly, a user can use his/her own mobile device 106 to control different sets of controllable devices 102 upon interaction with object 108. The location may display objects 108 by different sets of controllable devices 102. The user may then walk around the location and when the user sees a set of controllable devices 102 that the user would like to demo or control, the user can use his/her mobile device to interact with an object 108 that has been displayed by the set of controllable devices 102 and be allowed to control the set of controllable devices 102. Also, a user may view a webpage and see controllable devices 102 on the webpage the user would like to control. The user can interact with an object 108 that is displayed on the webpage to gain control of controllable devices 102.

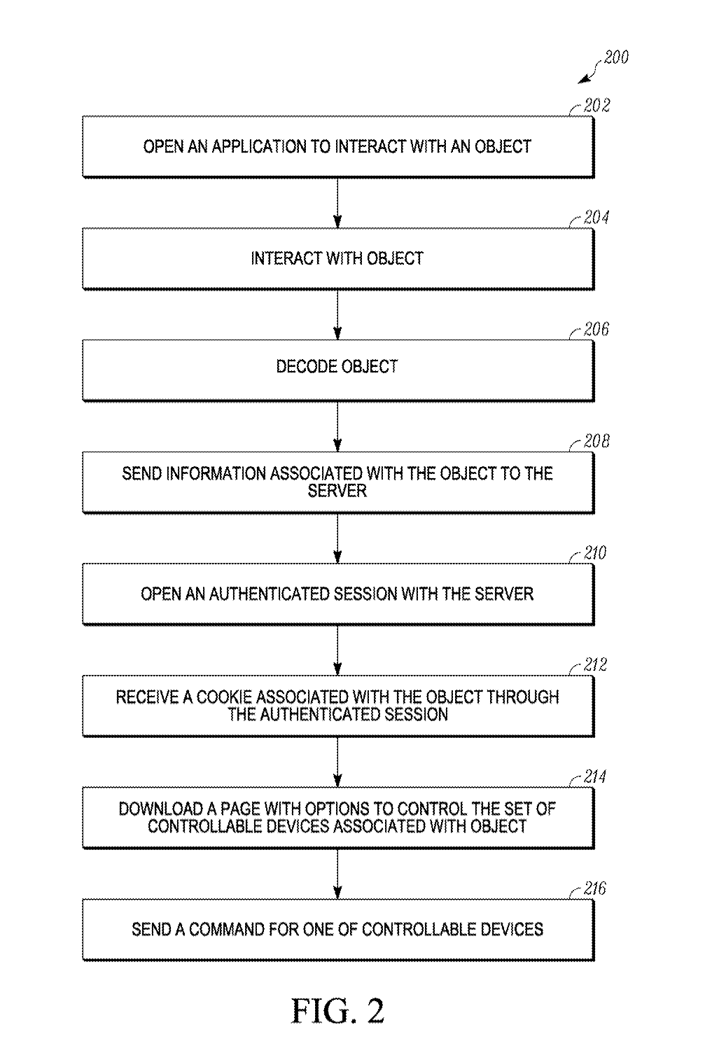

FIG. 2 depicts a simplified flowchart 200 for allowing a mobile device 106 to set up and control controllable devices 102 according to one embodiment. At 202, mobile device 106 may open an application to interact with an object 108. For example, the application may be a web browser that opens a web page to allow the user to scan object 108. Also, the application may be a native application on mobile device 106, such as a scanning application that allows a user to scan object 108 or may be a near-field communication application that allows a user to capture object 108.

At 204, mobile device 106 interacts with object 108. As discussed above, the object 108 may be captured via scanning, NFC, or another interaction. At 206, mobile device 106 may decode object 108. For example, if object 108 is displayed as a QR code, the QR code is decoded to determine information for object 108. In one example, the decoded information is a URL that is directed to server 104. The URL may also include information identifying a set of controllable devices 102.

At 208, mobile device 106 sends information associated with object 108 to server 104. Mobile device 106 may send a portion of the decoded information or information derived from the decoded information. For example, upon scanning object 108, a web browser may be launched on mobile device 106, and the web browser may automatically send the URL to server 104.

At 210, mobile device 106 opens an authenticated session with server 104. For example, server 104 may provide a session identifier (ID) to mobile device 106. The session ID is associated with the authenticated session. For example, any request to control controllable devices 102 that includes the session ID may be allowed while the authenticated session is valid. Also, a user may log in and provide credentials to server 104 to start an authenticated session. In other embodiments, the user may not have to log in and by virtue of providing object 108, and an authenticated session is opened. In other embodiments, security information, such as security keys, on mobile device 106 may be exchanged with server 104 to authenticate the session.

At 212, mobile device 106 receives a cookie associated with object 108 through the authenticated session. The cookie may be used to control the validity of the authenticated session. The cookie may keep track of information for the authenticated session that is used to determine whether the authenticated session is still valid. For example, the cookie may be used to track how long the authenticated session has been open. The authenticated session may then expire after a time limit. Also, the cookie may keep track of a number of scans of object 108 or a number of times a user sent commands to control the set of controllable devices 102. The authenticated session may end when the number of scans or commands reaches a threshold. This may allow a user time to control controllable devices 102, but requires the user to take some other action, such as purchasing the controllable devices 102 after a certain time. In one example, if mobile device 106 already has a cookie installed for object 108, a new cookie may not be sent, but rather information in the cookie may be reset.

At 214, mobile device 106 may download a page with options to control the set of controllable devices 102 associated with object 108. For example, a web browser may be launched and a web page is downloaded with content that allows the user to control the set of controllable devices 102 associated with object 108. Also, if an application (e.g., the web browser) is already opened, then that application may display a page that allows the user to control the set of controllable devices 102 associated with object 108. The page may display controls that are specific to the set of controllable devices 102. For example, if the set of controllable devices 102 are thermostats, the thermostat controls are displayed on the page. Also, if the set of controllable devices are lights, then light controls are displayed.

At 216, mobile device 106 sends a command for one of controllable devices 102. As will be discussed below, when server 104 receives the command, server 104 validates the session and may automatically control controllable device 102.

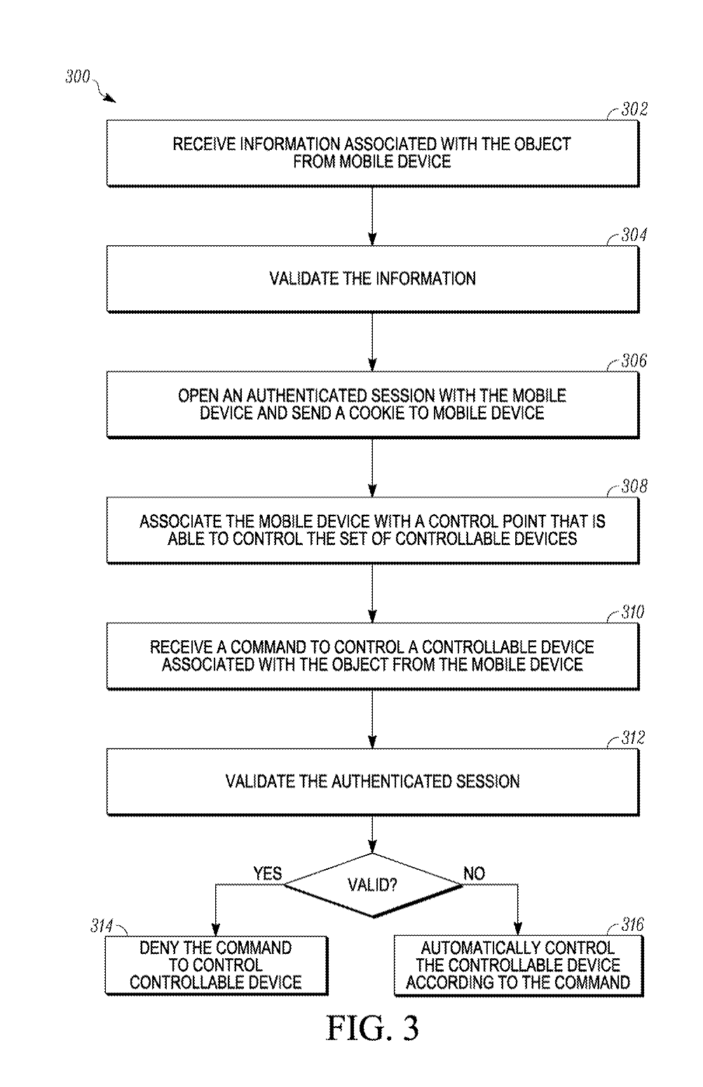

FIG. 3 depicts a simplified flowchart 300 for automatically controlling controllable devices 102 at server 104 according to one embodiment. At 302, server 104 receives information associated with object 108 from mobile device 106. At 304, server 104 validates the information. For example, objects 108 may expire after certain time periods. This may be because a store may not want continuous access to controllable devices 102. For example, a user could scan object 108 and then use the information indefinitely to control controllable devices 102. Thus, objects 108 may expire and thus any information sent that was determined from the decoded information from an expired object 108 would not be validated by server 104. If an object 108 expires, then a new object 108 may be displayed on display 110 with new decoded information (e.g., a new URL).

At 306, server 104 opens an authenticated session with mobile device 106 (assuming the information is validated) and sends a cookie to mobile device 106. The authenticated session may be opened as described above. The cookie may include information that is used for limiting the authenticated session's validity as discussed above. At 308, server 104 associates mobile device 106 with a control point 110 that is able to control the set of controllable devices 102 associated with object 108. For example, server 104 determines an applicable control point 110 that can process commands and control the set of controllable devices 102. Server 104 may associated the session ID with that control point 110, which indicates commands associated with that session ID should be allowed while the authenticated session is valid.

At 310, server 104 receives a command to control a controllable device 102 associated with object 108 from mobile device 106. The command may include the session ID and also an identifier for the controllable device 102. At 312, server 104 validates the authenticated session. Server 104 may determine if the session is still valid using different methods. For example, information in the cookie stored at mobile device 106 may be used to determine if the session is still valid. In one example, the cookie may store how many times object 108 has been scanned. If the number of scans exceeds a threshold, then the session may not be valid and the user may not be allowed to control controllable device 102 anymore. Also, the cookie may store a time period and a user may not be able to control controllable device 102 after the time period expires. Further, object 108 may also expire, and mobile device 106 cannot control controllable device 102 after object 108 expires. In this case, the session ID included with the request may be invalid. Thus, if the session is invalid, at 314, server 104 denies the command to control controllable device 102. If the session is valid, at 316, server 104 sends the command to control point 110, which automatically controls controllable device 102 according to the command. For example, if mobile device 106 wants to turn off a lamp, control point 110 turns the lamp off.

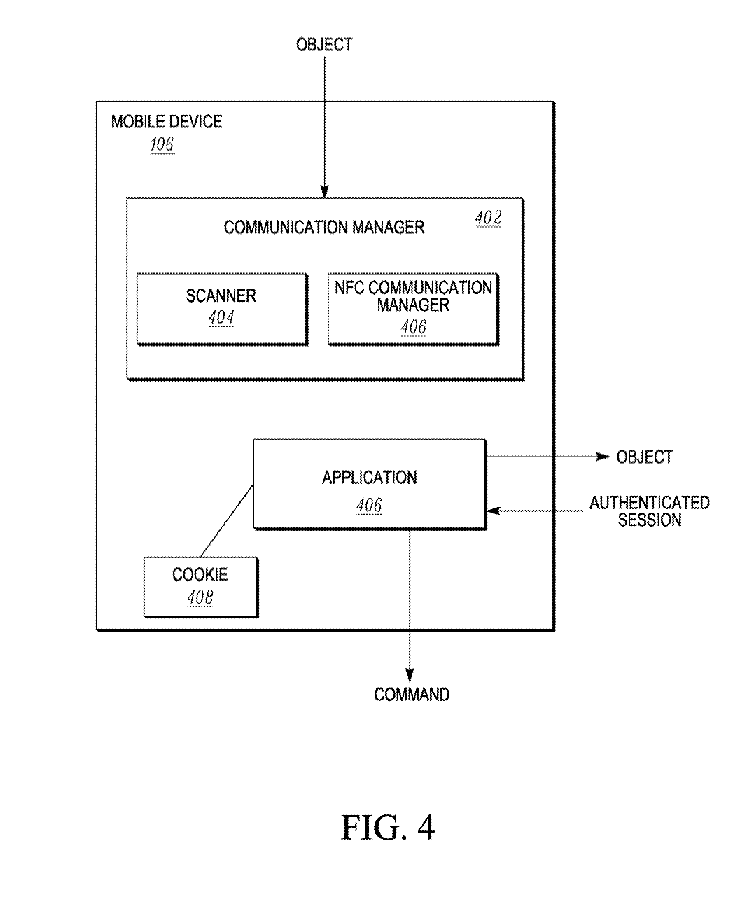

FIG. 4 depicts a more detailed example of mobile device 106 according to one embodiment. A communication manager 402 allows a user to capture object 108. For example, a scanner 404 or a near-field communication manager 406 are provided. Scanner 404 may include a camera or other scanning device. Near-field communication manager 406 allows mobile device 106 to communicate using NFC. Other communication methods may also be used to capture object 108.

An application 406 is used to control controllable devices 102. In one embodiment, application 406 may be a native application on mobile device 106, a downloaded application 406 from the store, or may be a web page that is downloaded by a web browser on mobile device 106. Application 406 sends information associated with object 108 to server 104 and also opens the authenticated session with server 104. Also, a cookie 408 may be received from server 104 and stored at mobile device 106.

Application 406 may display various controls for controllable devices 102 associated with object 108. When a user wants to control a controllable device 102, the user selects which controllable device 102 to control and a command for a feature to control. Application 406 then sends a command to server 104.

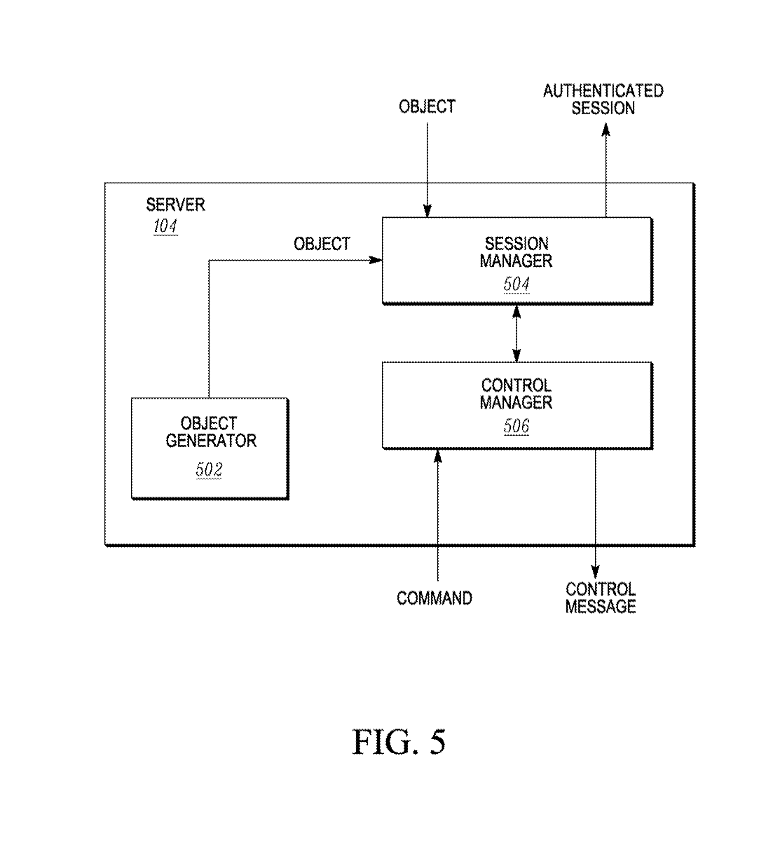

FIG. 5 depicts a more detailed example of server 104 according to one embodiment. An object generator 502 generates objects 108. For example, object generator 502 may generate a new object 108 for a set of controllable devices 102 over periodic intervals. In other embodiments, object generator 502 may print a physical object 108, such as on a piece of paper, once. Although object generator 502 is shown as being part of server 104, object generator 502 may be associated with a different entity, such as a server on a network coupled to server 104. In this case, object generator 502 may communicate object 108 when it is generated to server 104.

A session manager 504 of server 104 receives information associated with an object 108 from mobile device 106. Session manager 504 then validates the information and opens an authenticated session with mobile device 106. Session manager 504 may store information for the authenticated session, such as the session ID, the set of controllable devices 102 that can be controlled by mobile device 106 in this authenticated session, and a control point 110 to use.

A control manager 506 then allows mobile device 106 to control the set of controllable devices 102 associated with object 108. For example, control manager 506 receives a command from mobile device 106 and sends a control message to a control point 110 to automatically control a feature of that controllable device 102. Session manager 504 may also determine whether the authenticated session becomes invalid. For example, when control manager 506 receives a command, session manager 504 determines whether the authenticated session is still valid and the command should be performed. Also, over time, session manager 506 may invalidate the authenticated session, such as when a time period elapses.

Accordingly, a system to allow a user to control controllable devices 102 in a setting in which the user does not own controllable devices 102 is provided. For example, a user may be walking around a store and choose to capture an object 108 that is associated with a set of controllable devices 102 with his/her mobile device 106. Upon capturing object 108, the user is provided an authenticated session to control the set of controllable devices 102. In one embodiment, only capturing object 108 allows the user to control controllable devices 102. This allows a user to see how his/her mobile device 106 would be used to control the set of controllable devices 102.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
interacting, by a mobile device, with an object associated with a set of controllable devices that are provided for demonstration to a user of the mobile device;
determining information associated with the object based on the interaction;
sending the information to a server to open an authenticated session with the server, wherein the server opens the authenticated session based on the receiving of the information from the mobile device and the authenticated session allows temporary access to automatically control the set of controllable devices via an application running on the mobile device; and
sending, by the mobile device, a command to the server to control a controllable device in the set of controllable devices, wherein the server is configured to allow control of the controllable device based on the command if the temporary access to the authenticated session is determined to be valid for the mobile device and disallow the control of the controllable device if the authenticated session is determined to be invalid.

2. The method of claim 1, further comprising receiving a cookie from the server in the authenticated session, wherein information from the cookie is used to determine if the temporary access is determined to be valid.

3. The method of claim 2, wherein:
the cookie stores a number of scans of the object, and
the temporary access becomes invalid when the number of scans reaches a threshold.

4. The method of claim 2, wherein:
the cookie stores a time period, and
the temporary access becomes invalid when the time period expires.

5. The method of claim 1, wherein the mobile device is owned by the user and not a company demonstrating the set of controllable devices.

6. The method of claim 1, wherein interacting with the object comprises scanning a graphical representation associated with the object using the mobile device.

7. The method of claim 6, wherein the graphical representation comprises a quick response (QR) code that is generated by encoding the information associated with the object.

8. The method of claim 6, further comprising upon scanning the graphical representation, performing:
decoding encoded information in the graphical representation to determine the information, wherein the information identifies the server and the set of controllable devices; and
sending the information for the graphical representation to the server to open the authenticated session.

9. The method of claim 1, wherein interacting with the object comprises using near field communication to capture the information associated with the object.

10. The method of claim 1, further comprising upon interacting with the object, receiving a download of a page for the application to allow the control of the set of devices.

11. The method of claim 1, wherein:
the set of controllable devices that are provided for demonstration are provided in a different location from the user of the mobile device, and
a result of the command is viewable via an interface.

12. A non-transitory computer-readable storage medium containing instructions for controlling a computer system to be operable for:
interacting, by a mobile device, with an object associated with a set of controllable devices that are provided for demonstration to a user of the mobile device;
determining information associated with the object based on the interaction;
sending the information to a server to open an authenticated session with the server, wherein the server opens the authenticated session based on the receiving of the information from the mobile device and the authenticated session allows temporary access to automatically control the set of controllable devices via an application running on the mobile device; and
sending, by the mobile device, a command to the server to control a controllable device in the set of controllable devices, wherein the server is configured to allow control of the controllable device based on the command if the temporary access to the authenticated session is determined to be valid for the mobile device and disallow the control of the controllable device if the authenticated session is determined to be invalid.

13. A method comprising:
receiving, at a server, information associated with an object to open an authenticated session with mobile device, wherein the mobile device determined the information by interacting with the object associated with a set of controllable devices that are provided for demonstration to a user of the mobile device;
opening the authenticated session with the mobile device based on the receiving of the information associated with the object from the mobile device, wherein the authenticated session allows temporary access to automatically control the set of controllable devices via an application running on the mobile device;
receiving, at the server, a command from the mobile device to control a controllable device of the set of controllable devices;
validating if the temporary access is still valid for the authenticated session;
if the temporary access to the authenticated session is determined to be valid for the mobile device, allowing control of the controllable device based on the command; and
if the authenticated session is determined to be invalid, disallowing the control of the controllable device.

14. The method of claim 13, further comprising sending a cookie to the mobile device in the authenticated session, wherein information from the cookie is used to determine if the temporary access is determined to be valid.

15. The method of claim 13, wherein the mobile device is owned by the user and not a company demonstrating the set of controllable devices.

16. The method of claim 13, further comprising:
sending a session ID to the mobile device for the authenticated session;
associated the session ID with a control point configured to control the set of controllable devices;
receiving the session ID with the command from the mobile device; and
sending the command to the control point associated with the session ID to allow the control point to automatically control the controllable device.

17. The method of claim 13, wherein:
the object changes over time, and
the temporary access becomes invalid when the object changes.

18. The method of claim 13, wherein:
the set of controllable devices that are provided for demonstration are provided in a different location from the user of the mobile device, and
a result of the command is viewable via an interface.

19. A non-transitory computer-readable storage medium containing instructions for controlling a computer system to be operable for:
receiving, at a server, information associated with an object to open an authenticated session with mobile device, wherein the mobile device determined the information by interacting with the object associated with a set of controllable devices that are provided for demonstration to a user of the mobile device;
opening the authenticated session with the mobile device based on the receiving of the information associated with the object from the mobile device, wherein the authenticated session allows temporary access to automatically control the set of controllable devices via an application running on the mobile device;
receiving, at the server, a command from the mobile device to control a controllable device of the set of controllable devices;
validating if the temporary access is still valid for the authenticated session;
if the temporary access to the authenticated session is determined to be valid for the mobile device, allowing control of the controllable device based on the command; and
if the authenticated session is determined to be invalid, disallowing the control of the controllable device.

20. The non-transitory computer-readable storage medium of claim 19, further operable for sending a cookie to the mobile device in the authenticated session, wherein information from the cookie is used to determine if the temporary access is determined to be valid.
